(19) United States
(12) Patent Application Publication
(10) Pub. No.: US 2004/0049496 A1
(43) Pub. Date: Mar. 11, 2004

(54) Interactive searching system and method

(76) Inventors: Tal Rubenczyk, Tel Aviv (IL); Assaf Roth, Ramat Gan (IL); Harel Brown, Tel Aviv (IL); Oren Hod, Haifa (IL)

Correspondence Address: Anthony Castorina, G E Ehrlich, Suite 207, 2001 Jefferson Davis Highway, Arlington, VA, 22202, US

(21) Appl. No.: 10/362,095

(22) PCT Filed: Aug. 22, 2001
(86) PCT No.: PCT/IL01/00786

(30) Foreign Application Priority Data
Dec. 11, 2000 (IL) 140241

(51) Int. Cl. G06F 7/00

(52) U.S. Cl. 707/3

(57) ABSTRACT

The invention is directed to an interactive method for searching a database to locate desired items, even if the key words used as search criteria are not used to identify the item in the database. Another purpose of this invention is providing a method, which at the same time, reduces the results list based on user's response to a set of questions.

### FIELD OF THE INVENTION

The invention relates to a method far efficiently searching within a database. Particularly, the invention is directed to uses related to large databases, such as those used to search over the Internet.

### BACKGROUND OF THE INVENTION

Searching items over the Internet may be a difficult and frustrating process, because of the many different names by which an item can be found, and the relatively inefficient restriction methods employed by search engines to limit the number of results of a given search. In addition, a specific text can be found in a large number of irrelevant results. This is particularly true in the field of e-commerce. A specific product that is sold on the Internet (or outside it) may be know by many names. There is no unique name that relates a given product to its name. A search that is based only on the text of the product name, or even on the text of its specifications/categories, does not solve the above mentioned problems. On the one hand, the user may receive a large number of results in which the name of the product or its description contains a series of letters that fit the criteria used by the user, though these results are totally irrelevant. (For example—the user searches for a television, and obtains results dealing with a television table). On the other hand, the search results do not contain all the products that are relevant for the user, but which are not identified by the exact text that the user has entered as a search criterion.

The art has so far failed to provide an efficient solution to the abovementioned problems, although many attempts have been made, and several different search engines exist.

It is therefore an object of this invention to provide a method and a system which overcome the aforementioned problems of the prior art

It is another purpose of this invention to provide a simple interactive method by means of which the items actually desired by the user may be speedily located in a database that contains them, even if the keywords used as search criteria are not used to identify the item ion the database. The term “item”, as used herein, is meant to indicate any searchable matter, including words, text paragraphs, documents, etc., and is not limited to any particular, physical or otherwise, type of item.

It is yet another purpose of this invention to provide a method which, at the same time, amplifies and reduces the results list, to enable the user to locate the desired item, if it exists in the searched database, even if it is not directly retrievable by the search criterion used by the user.

Other purposes and advantages of this invention will appear as the description proceeds.

### SUMMARY OF THE INVENTION

The invention is directed to an interactive method for searching a database comprising the steps of:

receiving a search criterion from a user, or if no search criterion is provided, querying the user so as to generate a results space as hereinafter defined;

if a search criterion is provided, analyzing said search criterion to determine additional search criteria related thereto or stemming therefrom;

generating a results space comprising results selected from an existing database, which results are retrieved using the user's search criterion and the additional search criteria;

restricting the number of results in the results space by:

i) asking the user questions having two or more possible answers, each possible answer dividing the results space into different segments; and

ii) removing from the results space results which fall outside the segment of the results space that matches the user's answer.

In this Step i) above, the user can also insert additional text that will also be treated as information usable to divide the results space.

According to a preferred embodiment of the invention, the method further comprises repeating the step of restricting the number of results in the results space, until a predetermined number of total results is reached.

According to another preferred embodiment of the invention, the method further comprises repeating the step of restricting the number of results in the results space, until the user decides that the total number of results obtained is that from which he wishes to choose.

Of course, the user is not obliged to provide a positive answer to a given question, and in the case that he chooses not to answer a question, a further question is asked without previously segmenting the results space.

All the above characteristics and advantages of the invention will be better understood through the following illustrative and non-limitative description of preferred embodiments, with reference to the appended drawings.

### BRIEF DESCRIPTION OF THE DRAWINGS

FIGS. 1 through 5 schematically illustrate an example of a search, according to a preferred embodiment of the invention; and

FIG. 6 (A and B) is a simplified, schematic flow-chart illustrating the interaction of the user with the system.

### DETAILED DESCRIPTION OF PREFERRED EMBODIMENTS

Looking at the figures, the following steps illustrate the invention:

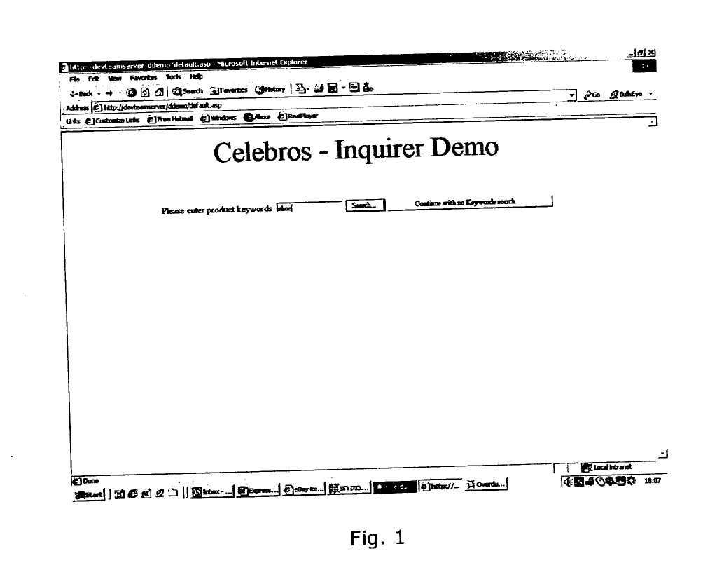

1. The user inserts a search criterion. In the example of FIG. 1 the search criterion (key word) is “shoe”. Of course, this key-word may be related to many different products that the user is searching.

2. The system searches in the database for matching products/results, which contains the text that the user had Inserted. The result of this search will be referred to as results space. The searched database might be, for example, the catalog of one or more stores.

3. The system expands the results space by adding other results (from the database), that although not containing the text the user had inserted, contain a related concept. This related concept may be a synonym, a similar context, etc. An algorithm that uses thesauruses, adaptive historical knowledge, self-conclusion engine etc, performs this expansion. Providing such algorithms, in order to expand the results space, if of course within the scope of the skilled person, and therefore is not described herein in detail for the sake of brevity.

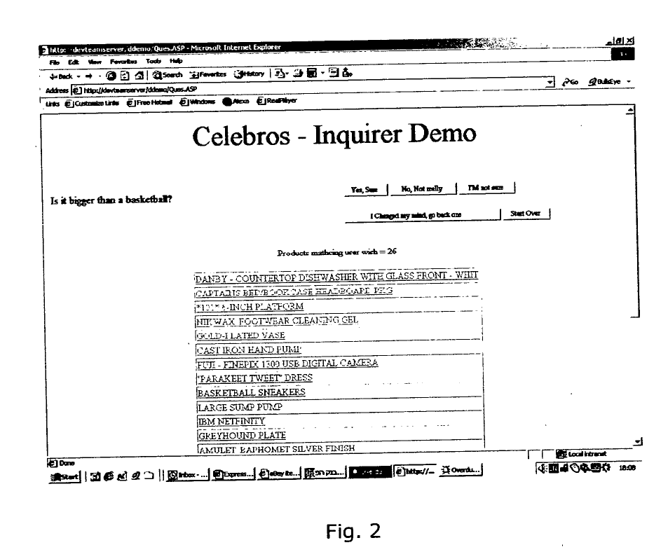

4. The results space, generated in Steps 2 and 3 above, is shown in FIG. 2.

5. The system analyzes this results space (online, or beforehand), using methods such as NLP, neural networks, pattern recognition, classification etc., which are well known to the skilled person The result of this analysis is a segmenting question, which divide the results space in the most efficient way. For example, in a multiple choice question, with X possible answers, each answer divides the results space to as close as possible to 1/x.

6. An example of question, with 2 possible answers (i.e., “Is it bigger than a basketball?”), is shown in FIG. 2.

7. After the user answers the question, the results space is reduced, and he all the matching results/products are displayed to him (as shown in FIG. 2). The user may choose not to answer a specific question (for example, when he does not know the answer). In this case, he clicks the button that says “I don't know”, and the system chooses another question. Alternativelt, it is also possible to present the user with several questions, and to ask him to choose which question he would like to answer.

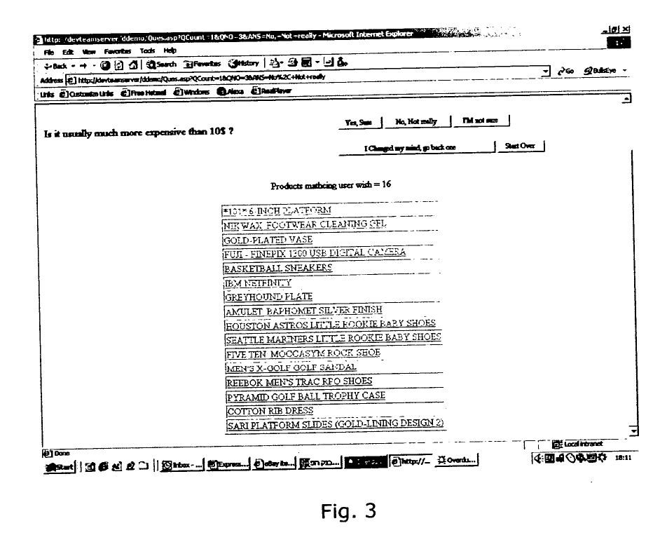

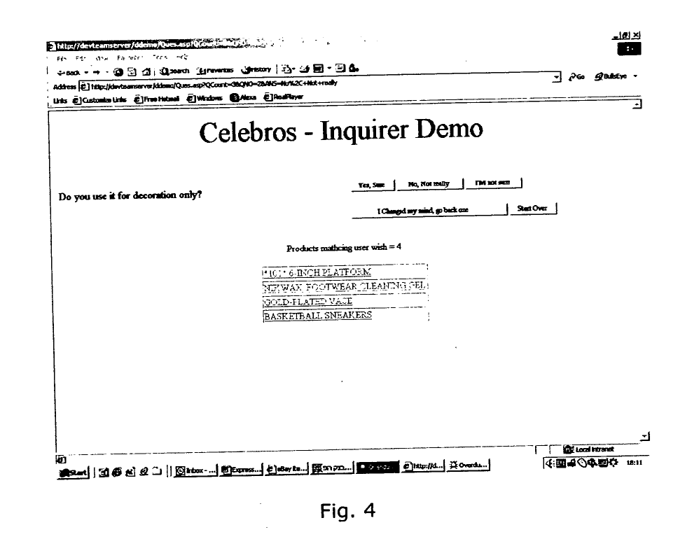

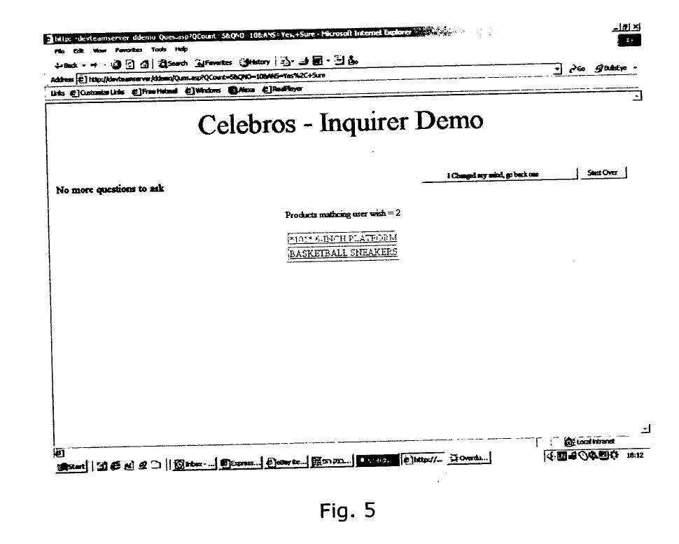

8. Stages 5-7 are repeated (stage 5 being performed each time on the new space result), until the user asks to stop, or until the system cannot generate more questions, or until there is a sufficiently small number of result The whole process is illustrated in FIGS. 2-5.

9. The user may choose a product, or may argue that the product that he wants, does not appear on the list. In this case, the system will present him other products that do not match all the answers of the user, but match some of them. If he chooses a product from the new list, the system will inform him about any contradiction between his answers and the knowledge of the system.

10. The system also acts as a learning system, and adapts its own information used to carry out the process, according to the result (i.e. product) that the user has chosen. This is done, for example, by correcting the correlations between the chosen product and the questions that the user has answered.

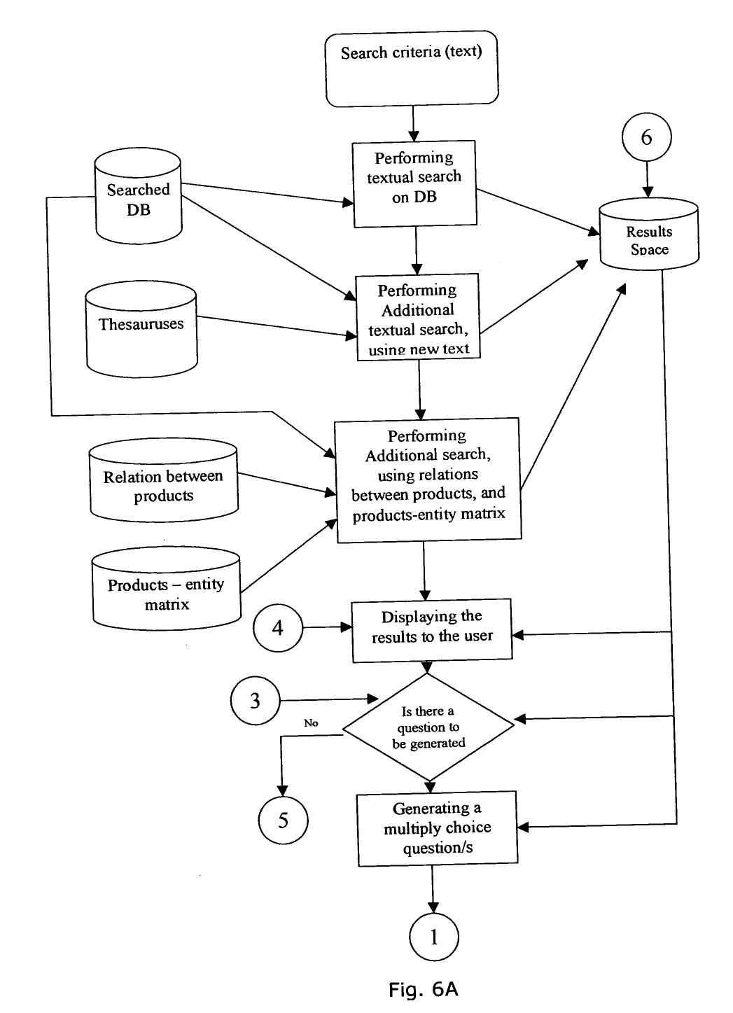

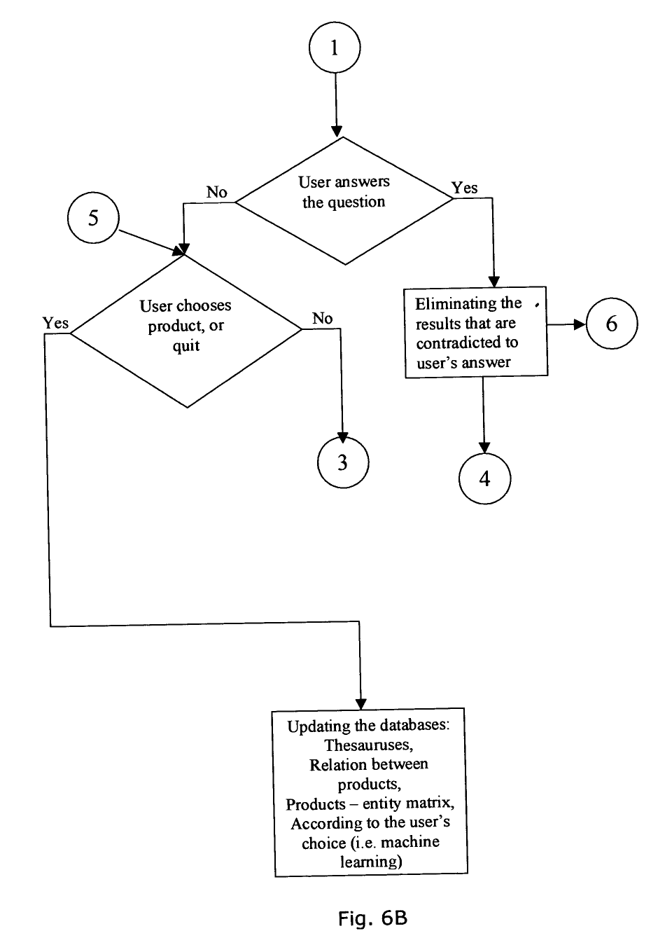

A process of the type described above, according to a preferred embodiment of the invention, is schematically illustrated in FIGS. 6 (A and B), and is self-explanatory. In the figure “DB” means “database”.

As will be apparent to the skilled person, the invention provides two novel and substantial improvements over the prior art:

1. The processes of expansion and reduction of the database, that enable the user to locate exactly what he wants, assuming it exists on the database, even if he doesn't know its exact name; and

2. The interaction with the user, in which the user is led to the product in which he is interested, in the most efficient way.

While embodiments of the invention have been described by way of illustration, it will be understood that the invention can be carried out by persons skilled in the art with many modifications, variations and adaptations, without departing from its spirit or exceeding the scope of the claims.

1. An interactive method for searching a database comprising the steps of:
receiving a search criterion from a user (not mandatory);
analyzing said search criterion to determine additional search criteria related thereto or stemming therefrom;
generating a results space comprising results selected from an existing database, which results are retrieved using the user's search criterion and the additional search criteria;
restricting the number of results in the results space by:
i) asking the user questions having two or more possible answers, each possible answer dividing the results space into different segments; and
ii) removing from the results space results which fall outside the segment of the results space that matches the user's answer.

2. A method according to claim 1, further comprising repeating the step of restricting the number of results in the results space, until a predetermined number of total results is reached.

3. A method according to claim 1, further comprising repeating the step of restricting the number of results in the results space, until the user decides that the total number of results obtained is that from which he wishes to choose.

4. A method according to any one of claims 1 to 3, wherein the user is not obliged to provide a positive answer to a given question, whereby a further question is asked without previously segmenting the results space.

5. An interactive method for searching a database, essentially as described and illustrated.
